(19) United States
(12) Patent Application Publication
(10) Pub. No.: US 2025/0205649 A1
(43) Pub. Date: Jun. 26, 2025

(54) POLYMER MEMBRANES INCORPORATED WITH CARRAGEENAN FOR WATER TREATMENT

(71) Applicant: Hamad Bin Khalifa University (HBKU), Doha (QA)

(72) Inventors: Saeed Hamad Al Marri, Doha (QA); Viktor Kochkodan, Doha (QA); Simjo Simson, Doha (QA); Jenny Lawler, Doha (QA)

(21) Appl. No.: 18/988,189

(22) Filed: Dec. 19, 2024

Related U.S. Application Data
(60) Provisional application No. 63/613,282, filed on Dec. 21, 2023.

(51) Int. Cl. B01D 65/08; B01D 61/14; B01D 67/00; B01D 69/02; B01D 71/68

(52) U.S. Cl. CPC B01D 65/08; B01D 69/02; B01D 71/68; B01D 61/145; B01D 67/0011; B01D 2323/21839; B01D 2325/02; B01D 2325/20

(57) ABSTRACT

A polymer member is provided. The polymer membrane includes a polymer layer including a polysaccharide, such as, carrageenan. The polymer layer may further include one or more of polyethersulfone, polysulfone, and polyvilidenefluoride.

### PRIORITY CLAIM

This application claims the benefit of and priority to U.S. Provisional Patent Application No. 63/613,282, filed Dec. 21, 2023, the entire disclosure of which is incorporated by reference herein.

### BACKGROUND

Ultrafiltration (“UF”) is an effective method for water treatment in protein-containing and oil-containing waste waters, which has many advantages for water treatment, such as (1) low cost and energy consumption; (2) high water flux; (3) efficiency in the removal of organic pollutants, microorganisms, and viruses; (4) low operation pressure; and (5) produces a small footprint. However, UF membranes have far-reaching applications beyond the realms of water treatment. UF membranes have been widely employed in the foodstuffs industry and in the pharmaceutical industry. Because of its versatility, the global UF membranes market is around $4.5 billion, registering an astonishing compound annual growth rate (“CAGR”) of 10.7% in the historical period between 2018 and 2022. The global UF membranes market is anticipated to rise at a CAGR of 8.0% up to 2033.

Polymer UF membranes are most commonly used commercially; however, there are several challenges related to fouling, chemical, mechanical, and thermal stability of the membranes. Membrane fouling, often described as the ‘Achilles heel’ of membrane technology, is a key problem which arises in real applications that rely on membrane processes. Membrane fouling is an extremely complex phenomenon that has not been defined precisely yet, however, in general, the term is used to describe the undesirable deposition of retained particles, colloids, macromolecules and salts, at the membrane surface or inside the membrane's pores.

Membrane fouling is a major factor in determining their practical application in water and wastewater treatment and desalination in terms of technology and economics. Membrane fouling has a number of detrimental effects on performance of the membrane systems including: (1) decline in the permeate flux; (2) deficiency in the solute removal; (3) drop of the transmembrane pressure; and (4) deterioration of the membrane's life span. The flux decline leads to increased feed pressure in order to maintain water filtration rates that boosts operation costs and leads to a larger carbon footprint due to the additional electrical consumption.

The membrane fouling is significantly affected by the type of membrane materials and their properties such as membrane hydrophilicity, surface charge, and porous membrane structure. It has been well documented that membranes with hydrophilic surfaces are less susceptible to fouling with organic substances, microorganisms, and charged inorganic particles due to a decrease in the interaction between the foulant and the membrane surface.

The surface charge of membranes is also important parameter for the reduction of membrane fouling where foulants are charged. When the surface and the foulant have similar charge, electrostatic repulsion forces between the foulants and the membrane prevent the foulant deposition on the membrane thereby reducing the fouling.

Most commercial membranes for pressure-driven processes are made from rather hydrophobic polymers such as polyvinylidenefluoride (“PVDF”), polyethersulfone (“PES”), polysulfone (“PS”), polyacrylonitrile, and polyamide. Usually, these materials are rather hydrophobic and characterized by high contact angle values and low surface charge. It has been well documented that membranes with hydrophobic surfaces and low surface charge are very susceptible to fouling with organic substances, colloids and microorganisms.

An increase in hydrophilicity, surface charge, porosity, and fouling resistance of polymeric membranes is highly desirable to minimize fouling and increase their productivity and efficiency when used in water treatment systems.

One of the main approaches to enhance membrane properties is through incorporation of hydrophilic additives (organic or inorganic) by blending those with the polymer membrane matrix. Some of these additives are organically-based such as polyvinylpyrrolidone and polyethylene glycol, whereas others are inorganically-based like alumina, silica, clay, or carbon-based materials. Some of these additives help in producing membranes with more macro-voids in the polymer matrix, whereas others surpass the formation of macro-voids. It was demonstrated that addition of Arabic gum to PES membrane raged the formation of porous structures, increasing the porosity of the membranes and enhancing the membranes surface charge, flux and antimicrobial properties against E. coli bacteria. Recently, a composite reverse osmosis membrane with improved properties was reported by incorporating acacia gum in the top layer of polyamide membrane.

Incorporation of carbon-based materials into polymeric-based membranes has been suggested in several studies to enhance the membrane properties. Some studies have explored the possibilities involving high grade graphene oxide and unmodified graphene acting as antimicrobial agents. One such study prepared PS UF membranes incorporated with varying amounts of halloysite nanotubes with enhanced compaction resistance. It was shown that the addition of 5 weight percent (“wt. %”) of halloysite nanotubes reduces the contact angle of the composite membrane by 14 degrees from the 78.7 degree of the pristine membrane. However, one of the challenges associated with the use of inorganic additives is their agglomeration in the polymer matrix.

Carbon nanotubes (“CNTs”) are among the additives that have gained popularity in the synthesis of nanocomposite membranes for water treatment. However, some studies show a toxic effect of CNTs on human health if leaked from the membrane to the treated water. In addition, the high cost of CNTs also limits CNTs application in membrane preparation.

Thus, there exists a need, for example, for an additive to minimize fouling without a toxic effect on human health to increase the productivity and efficiency of polymer membranes, such as when used in water treatment systems.

### SUMMARY

The present disclosure provides novel polymer membranes (e.g., UF polymer membranes), which possess enhanced performance and fouling resistance, by adding a natural polysaccharide, such as carrageenan, to the casting solution during the membrane preparation. The prepared polymer membranes are expected to be successfully employed in a number of suitable environmental and medical applications including water treatment.

By adding a natural polysaccharide, such as carrageenan, into a membrane body during the membrane preparation, membrane properties such as resistance to fouling and enhanced membrane service life, are improved. Polymer membranes loaded with carrageenan exhibit a number of enhanced membrane characteristics/properties, such as higher porosity, improved hydrophilicity, greater fouling resistance, higher flow rates, enhanced rejection capabilities, and improved permeate flux of carrageenan incorporated polymer UF membranes compared to commercial polymer UF membranes available in the market.

According to one non-limiting aspect of the present disclosure, an example embodiment of a polymer membrane is provided. In one embodiment, the polymer membrane includes a polymer layer which includes a polysaccharide.

In another aspect of the present disclosure, which may be combined with any other aspect listed herein unless specified otherwise, the polysaccharide is carrageenan.

In another aspect of the present disclosure, which may be combined with any other aspect listed herein unless specified otherwise, the polymer layer includes one or more of PES, PS, and PVDF.

In another aspect of the present disclosure, which may be combined with any other aspect listed herein unless specified otherwise, the polymer layer is loaded with carrageenan.

In another aspect of the present disclosure, which may be combined with any other aspect listed herein unless specified otherwise, the polymer layer is derived from a phase inversion casting process.

In another aspect of the present disclosure, which may be combined with any other aspect listed herein unless specified otherwise, the polymer layer is loaded with 0.1 wt. % to 4 wt. % of the carrageenan.

In another aspect of the present disclosure, which may be combined with any other aspect listed herein unless specified otherwise, the polymer layer is loaded with approximately 0.5 wt. % of the carrageenan and a porosity of the polymer membrane is 60% or greater.

In another aspect of the present disclosure, which may be combined with any other aspect listed herein unless specified otherwise, the polymer layer is loaded with approximately 0.5 wt. % of the carrageenan and a contact angle of the polymer membrane is less than 50 degrees.

In another aspect of the present disclosure, which may be combined with any other aspect listed herein unless specified otherwise, the polymer layer is loaded with 0.5 wt. % to 4 wt. % of the carrageenan and a pure water permeability of the polymer membrane is more than 1200 liter per hour per square meter (“LMH”)/bar.

In another aspect of the present disclosure, which may be combined with any other aspect listed herein unless specified otherwise, the polymer membrane contains bovine serum albumin (BSA).

In another aspect of the present disclosure, which may be combined with any other aspect listed herein unless specified otherwise, the polymer membrane contains approximately 200 ppm of BSA.

In another aspect of the present disclosure, which may be combined with any other aspect listed herein unless specified otherwise, the BSA is rejected by at least 97%.

In another aspect of the present disclosure, which may be combined with any other aspect listed herein unless specified otherwise, the polymer layer is loaded with at least 0.1 wt. % of the carrageenan and the polymer membrane contains approximately 200 ppm of BSA.

In another aspect of the present disclosure, which may be combined with any other aspect listed herein unless specified otherwise, the polymer layer is loaded with at least 0.5 wt. % of the carrageenan and permeate flux with 200 ppm BSA solution is more than 250 LMH.

In another aspect of the present disclosure, which may be combined with any other aspect listed herein unless specified otherwise, the BSA is rejected by at least 97.5%.

In another aspect of the present disclosure, which may be combined with any other aspect listed herein unless specified otherwise, a permeate flux of the polymer membrane is at least 250 LMH.

In another aspect of the present disclosure, which may be combined with any other aspect listed herein unless specified otherwise, a fouling of the polymer membrane is two times lower than without the carrageenan.

In another aspect of the present disclosure, which may be combined with any other aspect listed herein unless specified otherwise, a permeate flux of the polymer membrane is between 1200 and 1400 LMH.

In another aspect of the present disclosure, which may be combined with any other aspect listed herein unless specified otherwise, the polymer membrane is an UF membrane.

In another aspect of the present disclosure, which may be combined with any other aspect listed herein unless specified otherwise, the polymer membrane is loaded with carrageenan.

In another aspect of the present disclosure, which may be combined with any other aspect listed herein unless specified otherwise, the polymer membrane includes an applicator coating applied at a thickness of 200 μm.

Additional features and advantages are described by way of example in, and will be apparent from, the following Detailed Description and the Figures. The figures are schematic and are not intended to be drawn to scale. The features and advantages described herein are not all-inclusive and, in particular, many additional features and advantages will be apparent to one of ordinary skill in the art in view of the figures and description. In addition, any embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

Features and advantages of the present disclosure, including a polymer membrane, described herein may be better understood by reference to the accompanying drawings in which:

FIG. 1 is an image of the chemical structure of carrageenan, according to an embodiment of the present disclosure.

FIG. 2(a) is a scanning electron microscope (SEM) image of the surface of a plain PES membrane, according to an embodiment of the present disclosure.

FIG. 2(b) is a SEM image of the surface of a PES membrane with 4 wt. % carrageenan, according to an embodiment of the present disclosure.

FIG. 2(c) is a SEM image of the cross-section of a plain PES membrane, according to an embodiment of the present disclosure.

FIG. 2(d) is a SEM image of the cross-section of a PES membrane with 4 wt. % carrageenan, according to an embodiment of the present disclosure.

FIG. 3 is a graph illustrating the total porosity of PES membranes incorporated with carrageenan at different loadings in casting solutions, according to an embodiment of the present disclosure.

FIG. 4 is a graph illustrating the water contact angle of PES membranes incorporated with carrageenan at different loadings of the additive in the casting solution as well as water contact angles of various commercial PES membranes, according to an embodiment of the present disclosure.

FIG. 5 is a graph illustrating the water fluxes of PES membranes incorporated with carrageenan at different loadings of the additive in casting solutions, according to an embodiment of the present disclosure.

FIG. 6 is a graph illustrating the BSA rejection of PES membranes incorporated with carrageenan at different loadings of the additive in casting solutions at operating pressure of 1 bar and BSA concentration of 20 ppm, according to an embodiment of the present disclosure.

FIG. 7 is a graph illustrating the permeate fluxes of PES membranes incorporated with carrageenan at different loadings of the additive in casting solutions during filtration of BSA solution at operating pressure of 1 bar and BSA concentration of 200 ppm, according to an embodiment of the present disclosure.

FIG. 8 is a graph illustrating the reduction in fouling of PES membranes incorporated with carrageenan at different loadings of the additive in casting solutions after filtration of 200 ppm BSA solution at operating pressure of 1 bar, according to an embodiment of the present disclosure.

The reader will appreciate the foregoing details, as well as others, upon considering the following detailed description of certain non-limiting embodiments of the present disclosure.

### DETAILED DESCRIPTION

The present disclosure is generally related to a polymer membrane. More specifically, the present disclosure relates to a polymer member incorporated with a polysaccharide, such as a carrageenan, and for a number of suitable applications, such as for water treatment. Non-limiting embodiments of the present disclosure will be described by way of example with reference to the accompanying figures, which are not intended to be drawn to scale.

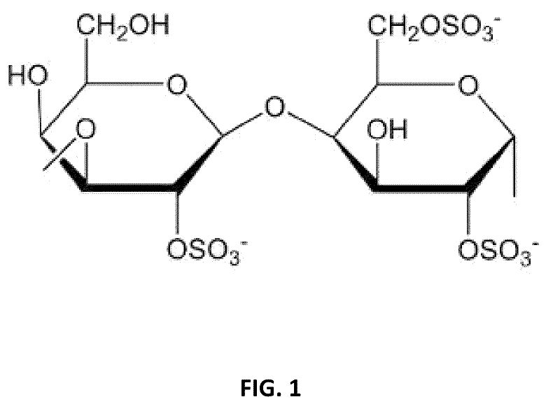

As described herein, “carrageenan” refers to the natural linear sulfated polysaccharide as illustrated in FIG. 1. Carrageenan is highly hydrophilic organic compound bearing negatively charged sulfonic groups. Carrageenan may be sourced from edible red seaweeds. Carrageenan has widespread use in commercial sectors as a gelling, thickening, and stabilizing agent, primarily in food production and condiments. Additionally, it finds applications in experimental medicine, pharmaceutical formulations, cosmetics, and various industrial processes.

To improve the performance and antifouling resistance of polymer membranes, such as UF polymer membranes, carrageenan is added to a casting solution during the preparation of the polymer membrane.

To demonstrate the effectiveness of carrageenan as an additive to enhance the membrane properties, polyethersulfone (“PES”), polysulfone (“PS”), or polyvinylidene fluoride (“PVDF”) membranes are cast via a phase inversion method using a flat sheet membrane casting system. In the experiments, the solubility of PES and PS at different polymer loadings of 14-20 wt. % in dimethyl acetamide (“DMAc”) and dimethyl sulfoxide (“DMSO”) solvents were tested. DMSO is a better fit for PES membrane preparation because of higher PES solubility.

For membrane casting, the required PES amount is dissolved in DMSO solvent by stirring at room temperature for 6 hours. The amount of PES varies in the range of 14-20 wt. %. An additional set of the PES membrane is prepared with addition of 0.1 wt. % carrageenan to the PES/DMSO solutions. Prior to adding PES, carrageenan is dissolved with DMSO by sonication.

An ultrasonic processor by 60% ample with a pulse every 5 seconds is used to facilitate dispersion of carrageenan into the solvent for 45 minutes. Once complete, the 16 wt. % PES is dissolved in DMSO with the carrageenan (which had previously been dissolved by stirring at 60° C. for 5 hours).

This solution is then cast into a membrane via a phase inversion method on a glass plate by using a Q TQC Sheen Film Applicator. The membrane is cast, at thicknesses 200 μm at casting speed of 20 cm/sec at room temperature. The glass plate with the cast membrane film is immersed in distilled water and kept until the membrane was detached from the glass plate. The membranes are then washed and kept in distilled water for 24 hours at room temperature to remove traces of the solvent.

The fabricated PES membranes incorporated with carrageenan are characterized by using scanning electron microscopy and tested by using contact angle, porosity, and filtration measurements.

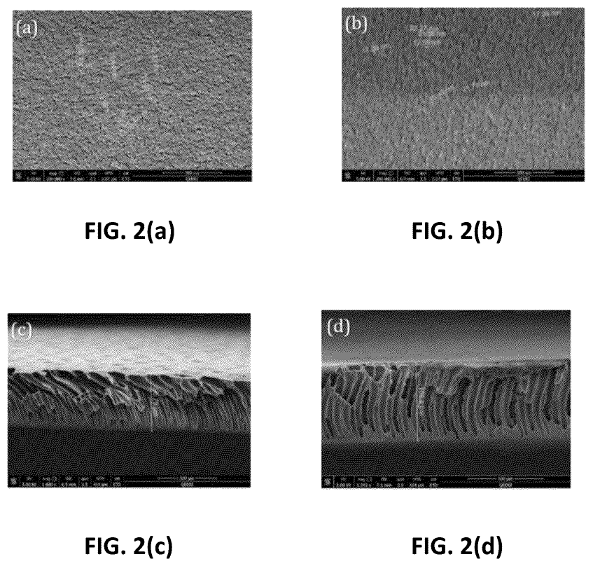

FIGS. 2(a)-2(d) illustrate scanning electron microscope (“SEM”) images of plain PES without carrageenan and PES with 4 wt. % carrageenan membranes. FIG. 2(a) is a SEM image of the surface of a plain PES membrane, whereas FIG. 2(c) is a SEM image of the cross-section of the plain PES membrane. Similarly, FIG. 2(b) is a SEM image of the surface of a PES membrane with 4 wt. % carrageenan, whereas FIG. 2(d) is a SEM image of the cross-section of a PES membrane with 4 wt. % carrageenan.

As seen in FIGS. 2(a)-2(d), the top surface and the cross-section of the PES membrane embedded with carrageenan have larger pores than the PES membrane without addition of carrageenan. This could be due to essential increase of hydrophilicity of the casting solution at carrageenan loading. As a result, a sharp increase in solvent/nonsolvent exchange takes place when the cast polymer film is immersed in the coagulation bath, which leads to fast polymer precipitation and formation of the enlarged pores in PES sample incorporated with carrageenan.

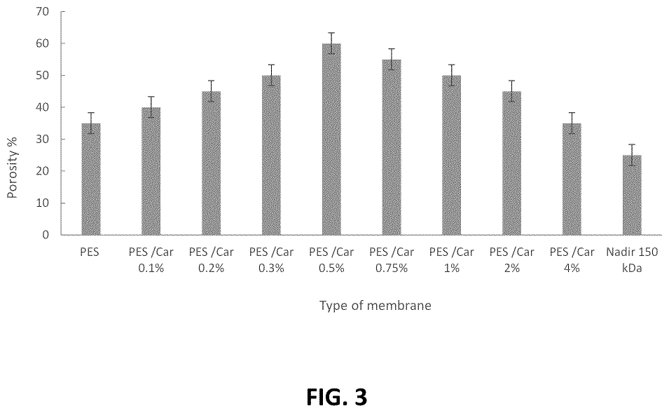

It is found that incorporation of carrageenan in polymer matrix notably improve the total porosity of PES membranes. FIG. 3 displays the total porosity (%) of the fabricated PES/carrageenan membranes at different carrageenan loadings. The total porosity of the membranes is calculated by cutting the membranes to a set measured size before weighing the membranes wet (W_{w}) (wiping excess deionized water droplets first) and then incubating them overnight at 45° C. The membranes are re-weighed the next day (W_{d}). Multiple samples were weighed in order to obtain an average set of values. The total porosity (ε) was calculated using the following equation: ε=((W_{w}−W_{d})/Alρ)*100.

As shown in FIG. 3, the addition of carrageenan had a profound impact on the total membrane's porosity of the prepared membranes. The PES membrane with 0.5 wt. %. carrageenan shows the highest value of the total porosity of about 60%, indicating a significant increase in the available pathways for water transport enhancing the membrane's filtration capabilities, while the total porosity value for the plain PES membrane without carrageenan is only about 35%. Remarkably, that the total porosity value for PES membrane with 0.5 wt. % carrageenan notably exceed the total porosity for commercial Microdin-Nadir PES 150 kDa membrane.

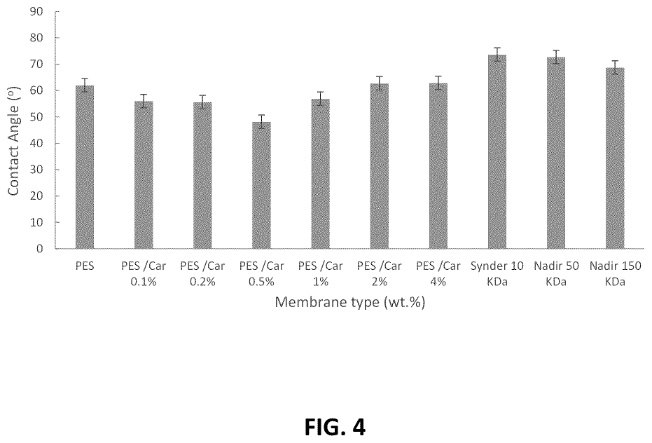

The incorporation of carrageenan in the polymer membrane matrix significantly increases the hydrophilicity of the membrane. FIG. 4 illustrates the contact angle values of the water droplet on the membrane's surface at different carrageenan loadings in the casting solutions. As shown in FIG. 4, the PES/carrageenan membrane having a 0.5 wt. % carrageenan loading shows the lowest value of the contact angle with a contact angle lower than 50 degrees. On the other hand, the plain PES without the addition of carrageenan shows the value of the contact angle of 62 degrees. This increased hydrophilicity is pivotal in reducing membrane fouling and ensuring the membrane's continuous operation in water treatment systems. It should be highlighted that water contact angle with PES/0.5 wt. % carrageenan membrane is notably lower compared to water contact angles for commercial Snider (PES 10 kDa) and Microdin-Nadir (PES 50 kDa and PES 150 kDa) membranes as shown in FIG. 4.

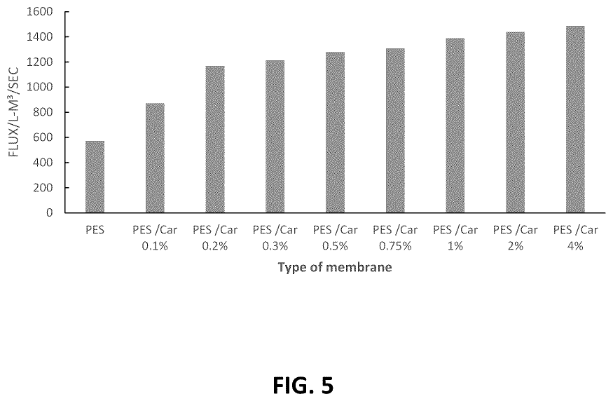

FIG. 5 illustrates the water fluxes of the fabricated PES membranes at different loadings of the carrageenan. The water fluxes are measured by using a Sterlitech HP4750X dead-end stirred cell (USA), and are pressurized under nitrogen gas. The water flux (J) was determined using the following equations: J=Q/AT, where Q is the total permeated volume collected in time T and A represents the effective cross-sectional area of the membrane in the filtration cell in m².

It was found that the PES membranes incorporated with carrageenan exhibited high water flux values. FIG. 5 illustrates the water fluxes of the fabricated PES/carrageenan membranes at different loadings of the additive. As seen in FIG. 5, all PES/carrageenan membranes possess much higher water flux values compared to the plain PES membrane without carrageenan. For example, PES membranes casted at 0.5 wt. % and 4 wt % loading of carrageenan in dope solutions possess the flux values of 1200 and 1400 LMH respectively while the plain PES membrane without carrageenan shows the lowest value of the water flux of 560 LMH.

The PES membranes are also tested with a BSA solution of 20 ppm concentration. The BSA solution testing results in high rejection rates for unwanted substances, such as the BSA itself, ensuring the effective removal of the contaminant from water. The BSA rejection (R) was calculated by the following formula: R=(1−Cₚ/C_{f})*100, where Cₚ is the concentration of BSA in the permeate and C_{f} is the concentration of the BSA in the feed solution. A Shimadzu spectrophotometer at 258 nm was used to measure the optical density (“OD”) of the permeate and feed solutions.

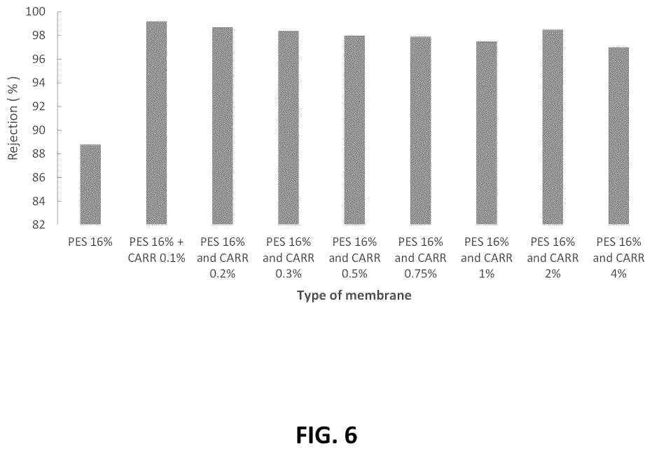

FIG. 6 illustrates BSA rejection with the fabricated PES/Carrageenan membranes at different loadings of the additive at an operating pressure of 1 bar and at BSA concentration of 20 ppm. As seen in FIG. 6, the prepared PES/carrageenan membranes have BSA rejection values higher than 97.5%, while the BSA rejection with the plain PES membrane without carrageenan was the lowest at 88.5%.

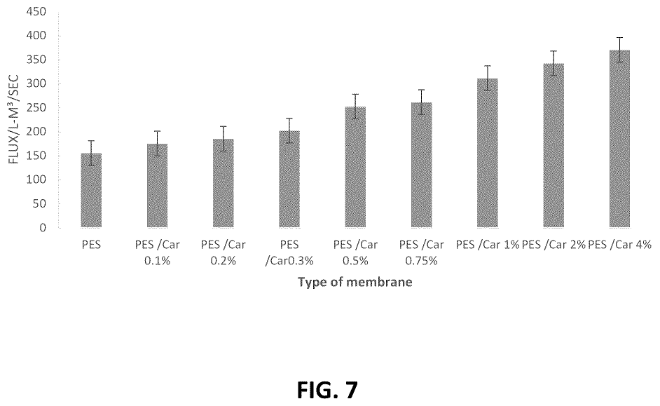

The PES membranes incorporated with carrageenan exhibited notably higher permeate fluxes during filtration of BSA solutions. FIG. 7 illustrates the permeate fluxes of the fabricated PES/carrageenan membranes at different loadings of the additive at an operating pressure of 1 bar and BSA concentration of 20 ppm. As seen in FIG. 7, permeate flux values for PES/carrageenan membranes are much higher compared to the plain PES membrane without carrageenan. For example, PES membranes having a 0.5 wt. % and 4 wt. % loading of carrageenan in dope solutions possess the permeate flux values of 250 and 350 LMH, respectively, while the plain PES membrane without carrageenan shows the lowest value of the permeate flux of 150 LMH. These findings illustrate the improved efficiency and productivity of carrageenan incorporated membranes in water treatment applications.

Adding carrageenan to PES membranes plays a pivotal role in reducing membrane fouling which was evaluated using the following equation: Fouling=(1−J_{f}/Jᵢ)*100, where J_{f} and Jᵢ are the water fluxes after and before filtration of BSA solution, respectively.

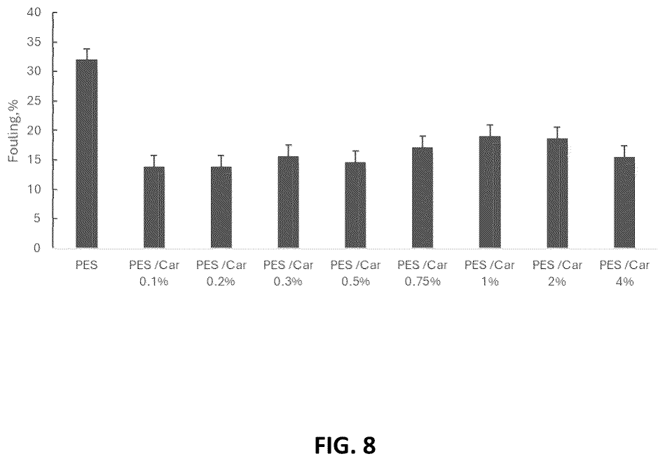

As seen in FIG. 8, the PES membranes incorporated with carrageenan showcased a remarkable reduction in fouling, up to 200% compared to the plain PES membrane without carrageenan. This reduction in fouling is crucial for maintaining the membrane's efficiency over time and minimizing the need for frequent maintenance and cleaning.

The prepared membranes showed higher resistance to BSA fouling than neat PES membranes, with a remarkable decrease in irreversible fouling while maintaining BSA rejection above 97% demonstrating high potential in treating protein-containing waters, which is of special importance in biotechnology and for treating wastewaters from dairy industry.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A polymer membrane comprising a polymer layer including a polysaccharide.

2. The polymer membrane according to claim 1, wherein the polysaccharide is carrageenan.

3. The polymer membrane according to claim 1, wherein the polymer layer includes one or more of polyethersulfone (PES), polysulfone (PS), and polyvilidenefluoride (PVDF).

4. The polymer membrane according to claim 3, wherein the polymer layer is loaded with carrageenan.

5. The polymer membrane according to claim 4, wherein the polymer membrane contains a bovine serum albumin (BSA).

6. The polymer membrane according to claim 1, wherein the polymer layer is derived from a phase inversion casting process.

7. The polymer membrane according to claim 4, wherein the polymer layer is loaded with 0.1 wt. % to 4 wt. % of the carrageenan.

8. The polymer membrane according to claim 4, wherein the polymer layer is loaded with approximately 0.5 wt. % of the carrageenan and a porosity of the polymer membrane is 60% or greater.

9. The polymer membrane according to claim 4, wherein the polymer layer is loaded with approximately 0.5 wt. % of the carrageenan and a contact angle of the polymer membrane is less than 50 degrees.

10. The polymer membrane according to claim 4, wherein the polymer layer is loaded with 0.5 wt. % to 4 wt. % of the carrageenan and a pure water permeability of the polymer membrane is more than 1200 LMH/bar.

11. The polymer membrane according to claim 5, wherein the polymer layer is loaded with 0.5 wt. % to 4 wt. % of the carrageenan and a BSA rejection is more than 97.5% with 200 ppm BSA solution.

12. The polymer membrane according to claim 5, wherein the polymer layer is loaded with at least 0.5 wt. % of the carrageenan and permeate flux with 200 ppm BSA solution is more than 250 LMH.

13. The polymer membrane according to claim 5, wherein the polymer layer is loaded with at least 0.1 wt. % of the carrageenan and fouling of the polymer membrane with 200 ppm BSA solution is more than 200% lower compared to a polymer membrane without the carrageenan.

14. The polymer membrane of claim 1, wherein the polymer membrane is an ultrafiltration membrane.

15. The polymer membrane of claim 14, wherein the polymer membrane is loaded with carrageenan.
